(19) United States
(12) Patent Application Publication
(10) Pub. No.: US 2016/0011928 A1
(43) Pub. Date: Jan. 14, 2016

(54) LOG OUTPUT CONTROL DEVICE, METHOD, AND COMPUTER-READABLE RECORDING MEDIUM

(71) Applicant: NEC CORPORATION, Minato-ku, Tokyo (JP)

(72) Inventor: Takumi FUJIWARA, Tokyo (JP)

(73) Assignee: NEC Corporation, Minato-ku, Tokyo (JP)

(21) Appl. No.: 14/772,125

(22) PCT Filed: Mar. 18, 2014
(86) PCT No.: PCT/JP2014/057311

§ 371 Date: Sep. 2, 2015

(30) Foreign Application Priority Data
Mar. 26, 2013 (JP) 2013-063593

(51) Int. Cl. G06F 11/07

(52) U.S. Cl. CPC G06F 11/0778; G06F 11/0709; G06F 11/0751

(57) ABSTRACT

Provided is a log output control device that dynamically controls the log output location in a program that is requested by a client using a log history output by the client, irregular operation information that is related to irregular operation of a program that is detected from the log, and log generation information that is related to log output processing that is inserted in a program executed by the client.

### TECHNICAL FIELD

The present invention relates to a log output control device, method, and program.

### BACKGROUND ART

Recently, as for a portal product, by prevalence of Ajax (Asynchronous JavaScript (registered trade mark)+XML), HTML5, CSS3 (Cascading Style Sheets, level 3), and JavaScript library, it has become mainstream to shift, to a client side, a function provided on a server side, so that an advanced function is implemented by a client. Thereby, a process adjusted for an implemented client can be performed, and for this reason, it becomes possible to implement provision of a fine picture and the like. By shifting a process on a server side to a client, a load can be dispersed to a client side even when the number of users increases. By such transfer of a process to a client side, the merit can be obtained, whereas some problems are revealed.

Prevalence of a smartphone and a tablet generates a necessity of development covering not only personal computer (PC) environment but also a mobile device environment, and for a system that provides a client-side script, it is urgently needed to deal with expansion of a platform. In addition, while a browser is diversified, development and a test environment of a client that absorbs a difference in behavior of the respective browsers and the like are not sufficiently improved. Although using a library provided by open source software (OSS) enables absorption of a part of difference of the browsers, use of a library cannot achieve 100% of compensation, and for this reason, abundant knowledge such as that of coding adjusted for behavior of each browser is required of a developer. Since a process expected on a client side becomes complex, how much detailed debug information of a client environment can be acquired at the time of occurrence of malfunction becomes a key at the time of analyzing malfunction.

To facilitate such malfunction analysis on a client, a client transmits, to a server, a log for malfunction analysis. The transmission of the log to a server side enables collection of debug information, but as the number of users increases, an amount of logs transmitted to a server drastically increases. In a large-scale system, when all clients equally transmit logs, loads of a server and a network become high, and for this reason, not only its own system but also another system are affected. Accordingly, there is a problem that operation in a large-scale system on a cloud becomes difficult.

For example, the patent literature 1 describes a system that uses terminal information to collect only a log of a terminal where malfunction has occurred, and thereby prevents a recorded amount of logs from becoming enormous.

### CITATION LIST

### Patent Literature

[PTL 1] Japanese Laid-open Patent Publication No 2010-117934

### SUMMARY OF INVENTION

### Technical Problem

By limiting a log collecting target to a client where malfunction has occurred as in the system of the patent literature 1, the amount of recorded logs can be held down to some extent. Recently, however, it has become mainstream to shift a function provided on a server side to a client side.

In this circumstance, the number of clients where malfunction occurs increases largely, and thus, when all the clients equally transmit logs, loads of a server and a network become high as before.

In view of the above-described problem, the present invention has been made, and an object of the present invention is to provide log output control device, method, and program that can efficiently control a log output process in a client.

### Solution to Problem

A log output control device of the present invention dynamically controls a log output location in a program requested by a client, by using a history of a log output by the client, wrong operation information concerning wrong operation of the program detected from the log, and log generation information concerning a log output process inserted in the program executed by the client.

A log output control method of the present invention includes

controlling dynamically a log output location in a program requested by a client, by using a history of a log output by the client, wrong operation information concerning wrong operation of the program detected from the log, and log generation information concerning a log output process inserted in the program executed by the client.

A program of the present invention causing a computer to execute a process of dynamically controlling a log output location in a program requested by a client, by using a history of a log output by the client, wrong operation information concerning wrong operation of the program detected from the log, and log generation information concerning a log output process inserted in the program executed by the client.

### ADVANTAGEOUS EFFECTS OF INVENTION

According to the present invention, a log output process in a client can be efficiently controlled.

### BRIEF DESCRIPTION OF DRAWINGS

FIG. 1 is a conception diagram of the present invention.

FIG. 2 is a configuration diagram of a first exemplary embodiment of the present invention.

FIG. 3 is a diagram exemplifying log generation information.

FIG. 4 is a diagram exemplifying wrong operation information.

FIG. 5 is a diagram exemplifying an event history.

FIG. 6 is a diagram illustrating constituent elements of a system of the first exemplary embodiment, and flow of respective operation processes.

FIG. 7 is a diagram for illustrating a process of embedding, in a script file, a log output process for analyzing malfunction.

FIG. 8 is a flowchart for illustrating a log-output-process inserting process.

FIG. 9 is a flowchart for illustrating an event history writing process.

FIG. 10 is a flowchart for illustrating a wrong information writing process.

FIG. 11 is a diagram exemplifying scripts in which log output processes are inserted.

FIG. 12 is a configuration diagram of a second exemplary embodiment of the present invention.

FIG. 13 is a diagram for illustrating a rule for performing identification of a user.

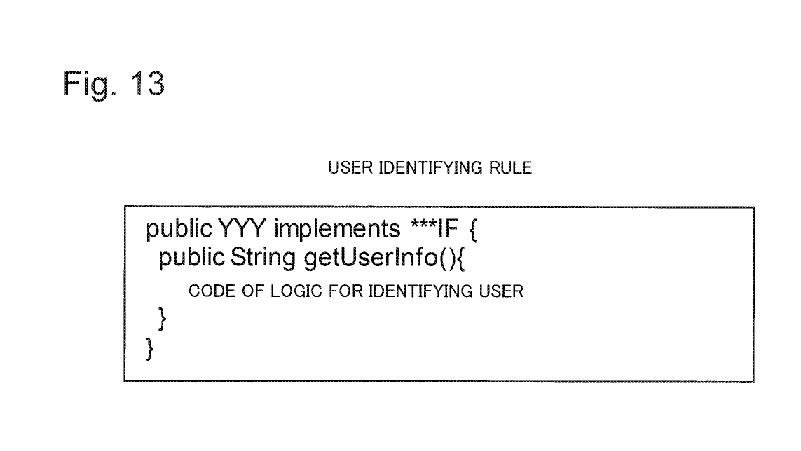

FIG. 14 is a diagram illustrating an example of an output result in the second exemplary embodiment.

FIG. 15 is a configuration diagram of a third exemplary embodiment of the present invention.

### DESCRIPTION OF EMBODIMENTS

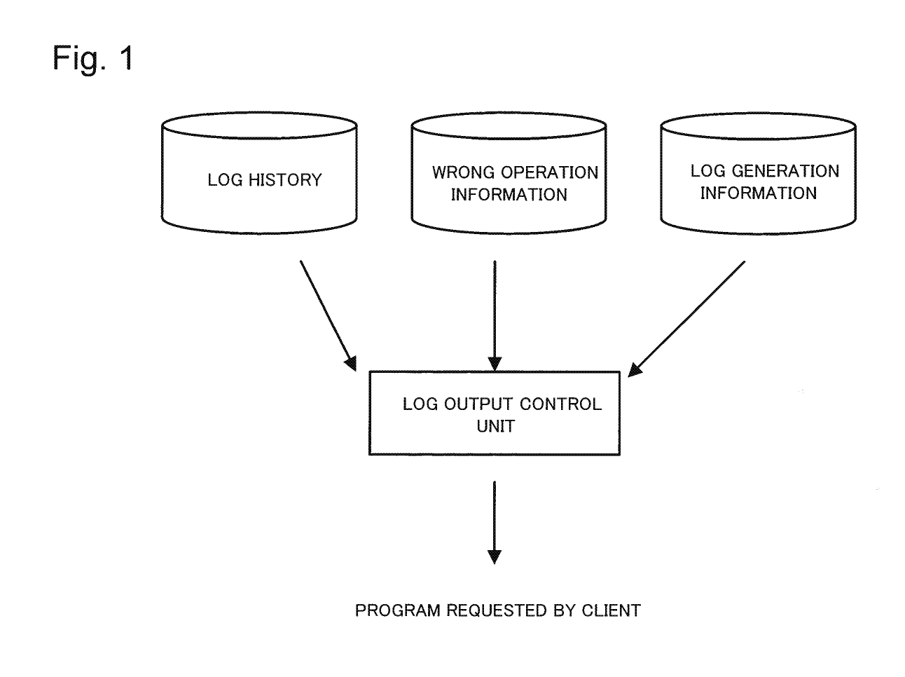

The present invention relates to a log output control device that dynamically controls a log output location in a program requested by a client. The log output control device uses a history of logs output by the client, wrong operation information concerning wrong operation of the program detected from the log, and log generation information concerning a log output process inserted in the program executed by the client, as illustrated in FIG. 1.

### First Exemplary Embodiment

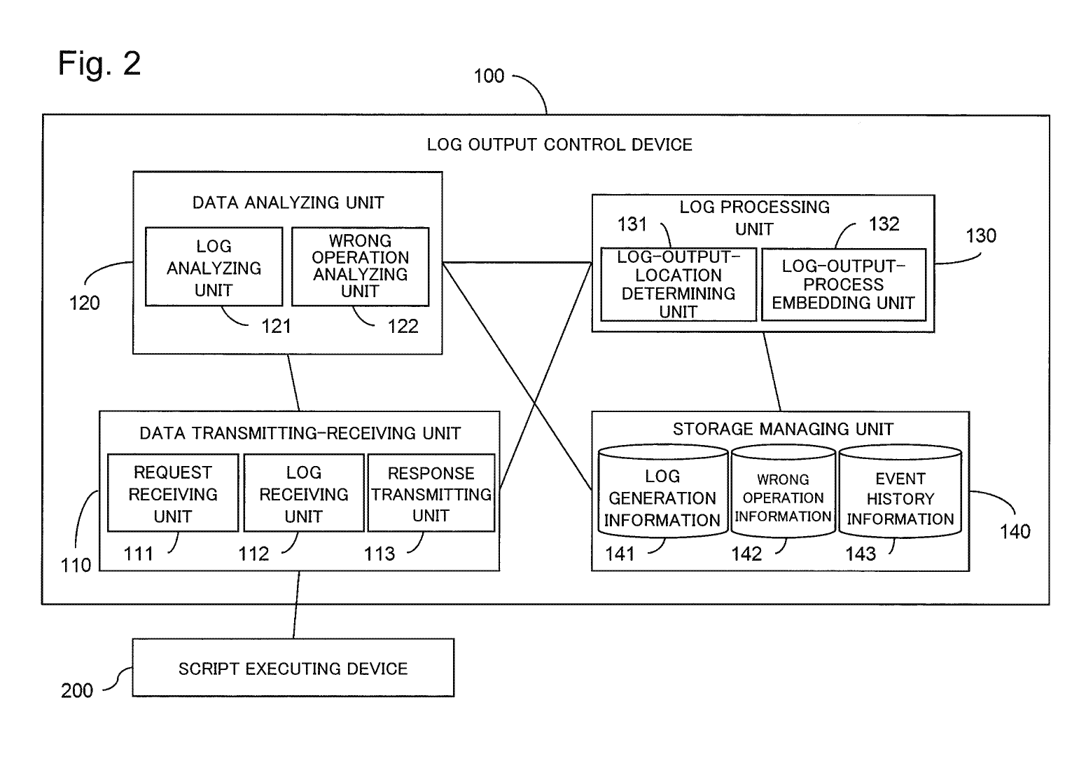

FIG. 2 is a configuration diagram of a first exemplary embodiment of the present invention.

The first exemplary embodiment includes a log output control device 100 and a script execution device 200. In the present exemplary embodiment, the log output control device 100 is a portal server, and the script execution device is a client including a web browser, a script execution engine, and the like. These are connected to each other by a network such as the Internet.

In the following, description focuses on the log output control device 100 on a server side that is an important part of the present invention.

The log output control device 100 includes a data transmitting-receiving unit 110, a data analyzing unit 120, a log processing unit 130, and a storage managing unit 140.

The data transmitting-receiving unit 110 includes a request receiving unit 111, a log receiving unit 112, and a response transmitting unit 113.

The data analyzing unit 120 includes a log analyzing unit 121 and a wrong operation analyzing unit 122. The log analyzing unit 121 specifies log ID from a recorded log message, and registers the log ID in an event history. The wrong operation analyzing unit 122 detects (extracts) wrong information when an error is set in the message registered in the event history.

The log processing unit 130 corresponds mainly to a log output control unit in FIG. 1, and includes a log-output-location determining unit 131 and a log-output-process embedding unit 132. The log-output-location determining unit 131 determines a log output location in a script provided to a client side, based on the wrong operation information and log generation information concerning past log output. The log-output-process embedding unit 132 is provided to actually embed a log output process.

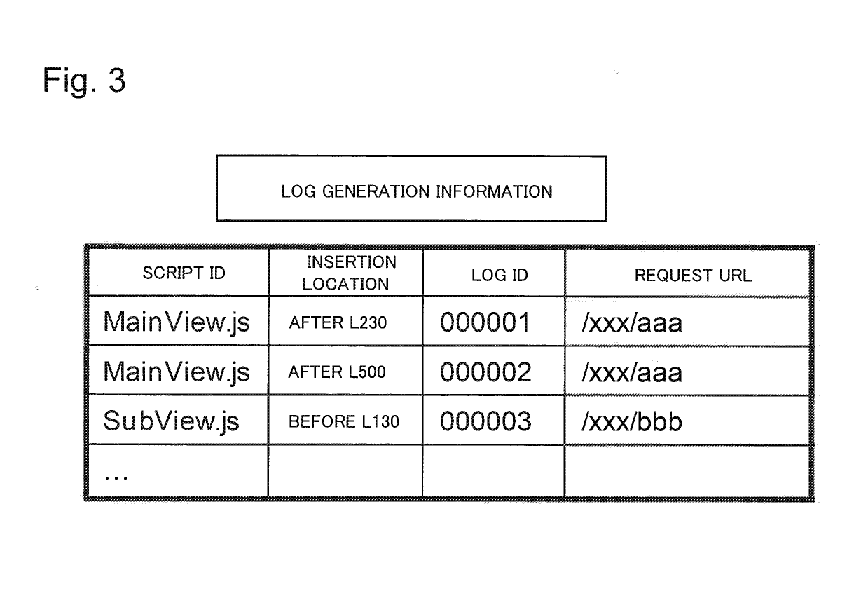

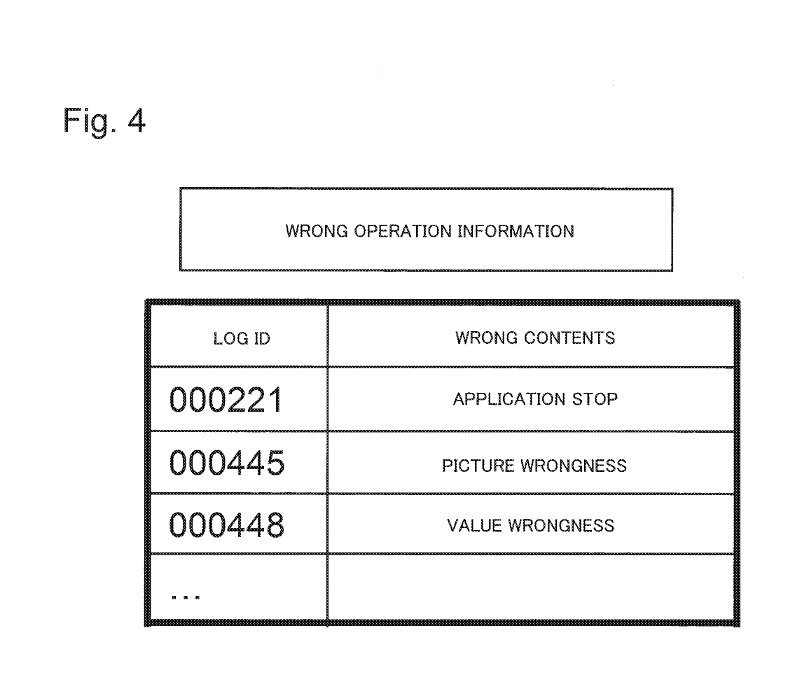

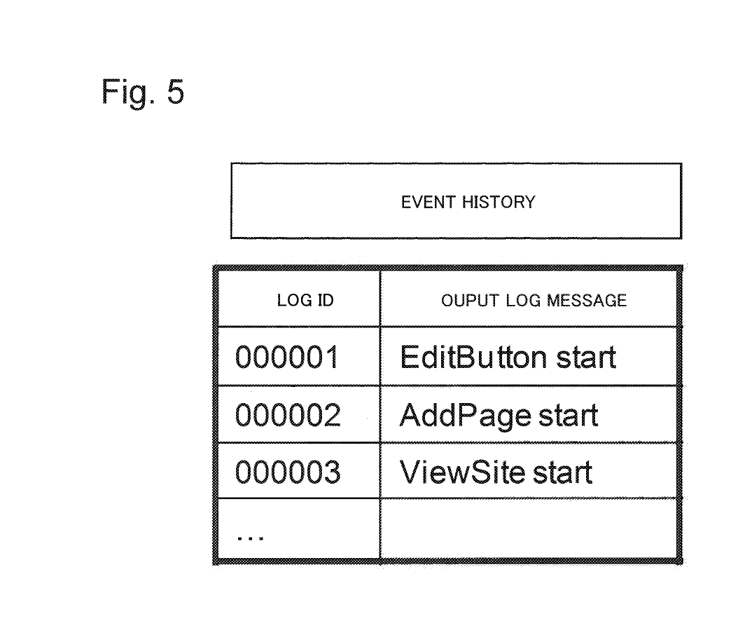

In the storage managing unit 140, log generation information 141, wrong operation information 142, and event history information 143 is stored. The log generation information 141 is information concerning the log output process inserted in a script, and is information including log ID, an insertion location (a file name, ID, and the line number of a script), and request URL as exemplified in FIG. 3. The wrong operation information is information concerning wrong operation of a script detected based on a log, and is information including log ID of a log detected wrong operation, and including wrong operation contents as exemplified in FIG. 4. The event history is information concerning a log received from a client, and includes log ID and an output log message as exemplified in FIG. 5.

Next, operation of the present exemplary embodiment is described.

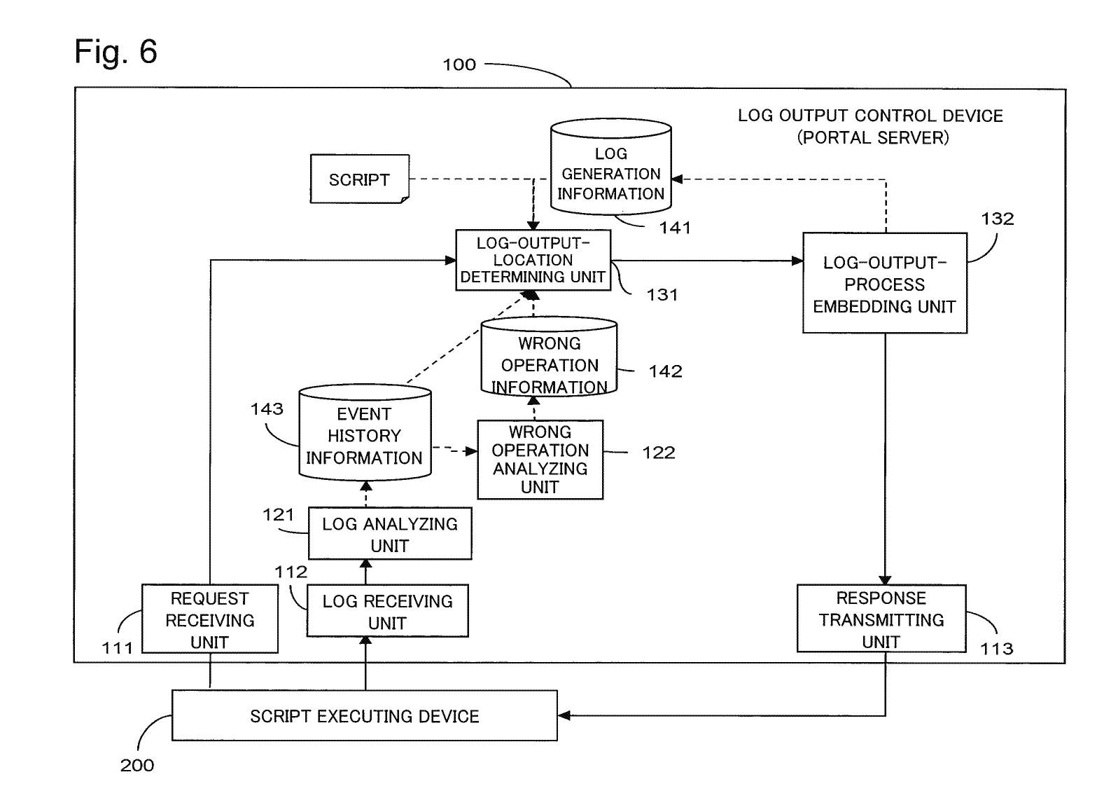

FIG. 6 illustrates constituent elements of the present system, and flow of respective operation processes.

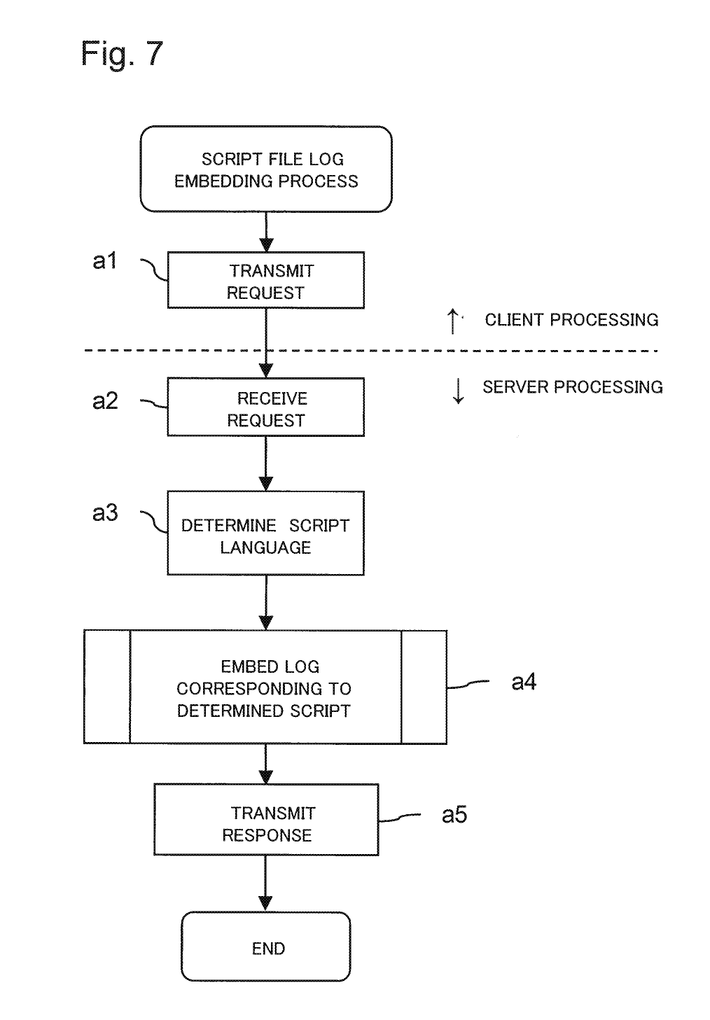

First, with reference to a flowchart of FIG. 7, a process of embedding, in a script file, a log output process for malfunction analysis is described.

A web browser of the client (script execution device 200) transmits, to the portal server (log output control device 100), an HTTP request for obtaining a server resource including a source of JavaScript (a1).

When the portal server receives the HTTP request (a2), the portal server determines a script language to be transmitted to the client (a3), and performs a log-output-process inserting process for JavaScript (a4).

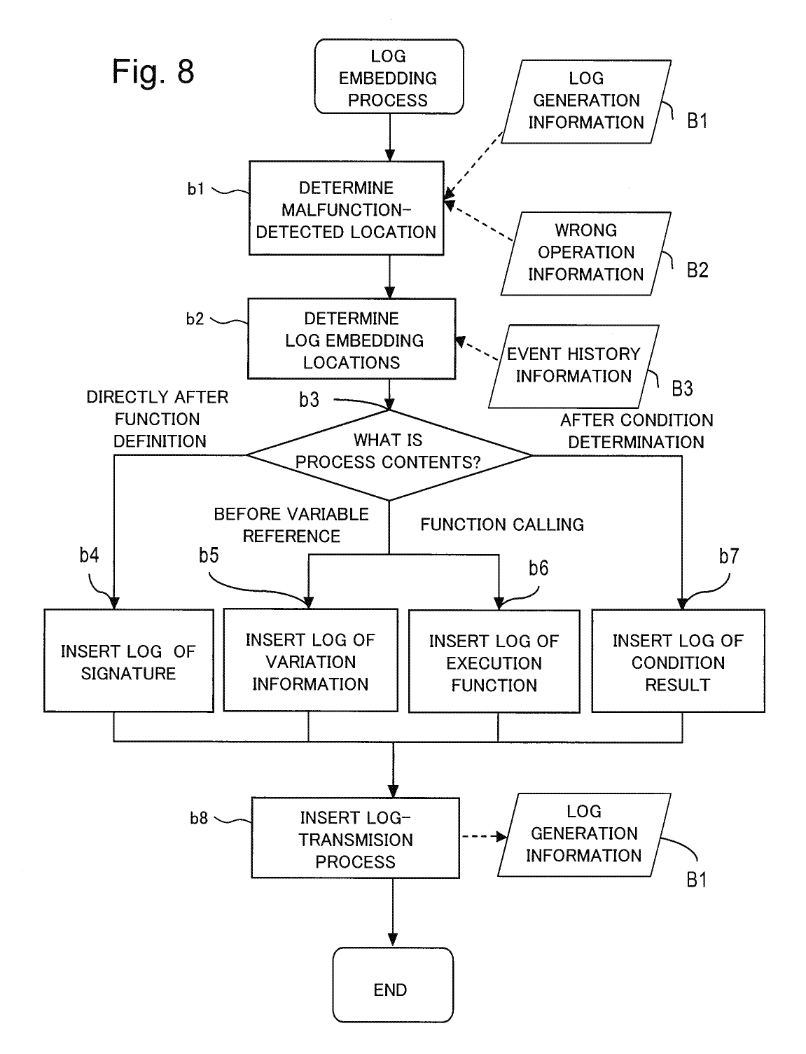

Here, details of the log-output-process inserting process at (a4) are described with reference to FIG. 8.

In the log-output-process inserting process, first, the portal server reads the log generation information (B1) and the wrong operation information (B2), and if the wrong operation information exists, based on log ID of the wrong operation information, the portal server retrieves the log generation information of the same log ID. Regarding the execution result involved, the portal server specifies the JavaScript line number where the log output process is embedded, and finds a malfunction-generated location in the script (b1).

Next, the portal server reads a script file of an actual request target, and determines embedding locations of log output processes (b2). The number of log output locations is increased around the malfunction-detected location specified earlier. At this time, the portal server uses event history information [log ID] (B3) to determine whether or not a function of the script has already been executed. Setting of decreasing the number of log output processes to be low is made by the portal server in the function regarding which the execution record exists in the event history information, and regarding which it is indicated by reference to the wrong operation information that malfunction has not been generated. When insertion locations of log output processes are determined, the portal server then generates log messages [additional information such as a function name, start/end/error, a variable, and a signature] in accordance with process contents, and inserts log output processes (b4 to b7). When insertion of log output processes is ended, the portal server inserts a log transmission process to a server (b8). At this time, the portal server records log generation information (B1) also in a log generation information table.

The portal server then transmits script, in which the log output processes have been embedded, to the client (FIG. 7: a5).

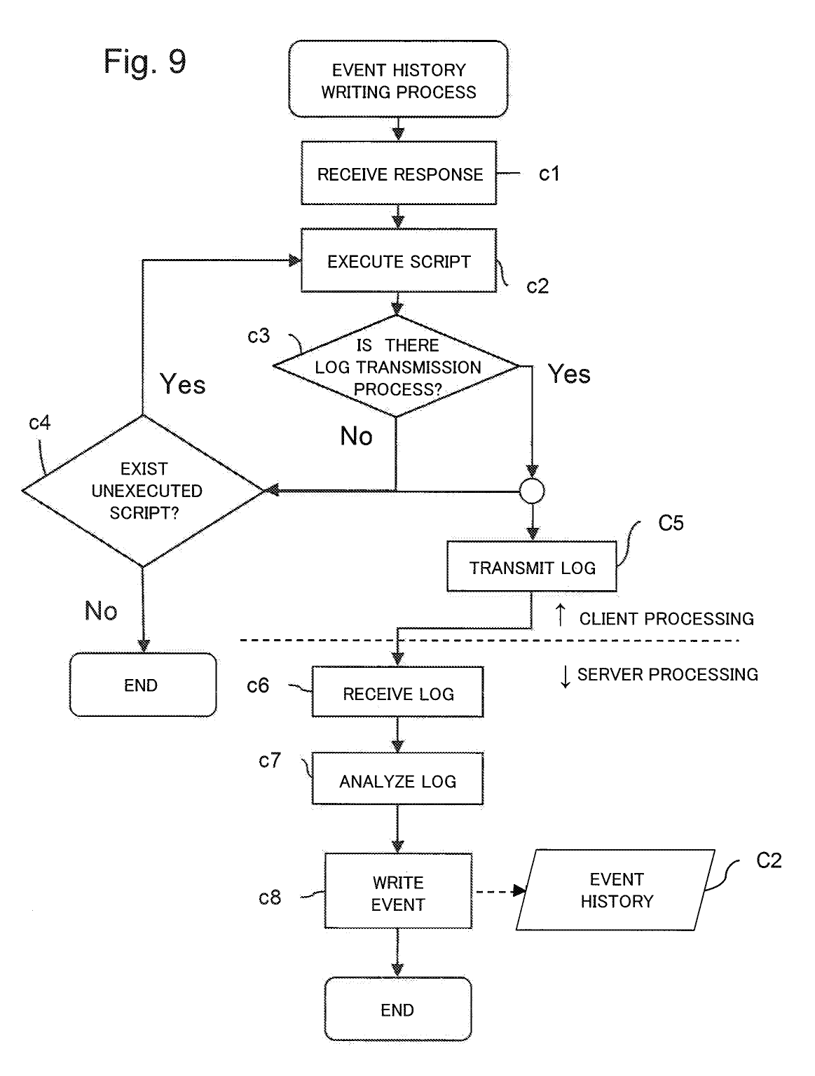

Next, an event history writing process is described by using FIG. 9.

When response data including the script (JavaScript) is received from the portal server (c1), the browser of the client performs analysis and execution of the HTML and JavaScript script (c2). The browser re-reads only the updated JavaScript, and uses a cache for other JavaScript files. When the re-reading is performed, an original defined function is overwritten by a function in which a new log output process is described. When a log transmission process is described in the executed script (c3), log transmission to the portal server is performed (c5).

When the portal server receives a log (c6), the portal server analyzes the received log (c7), and writes the result of the analysis in the event history information (C2), (c8).

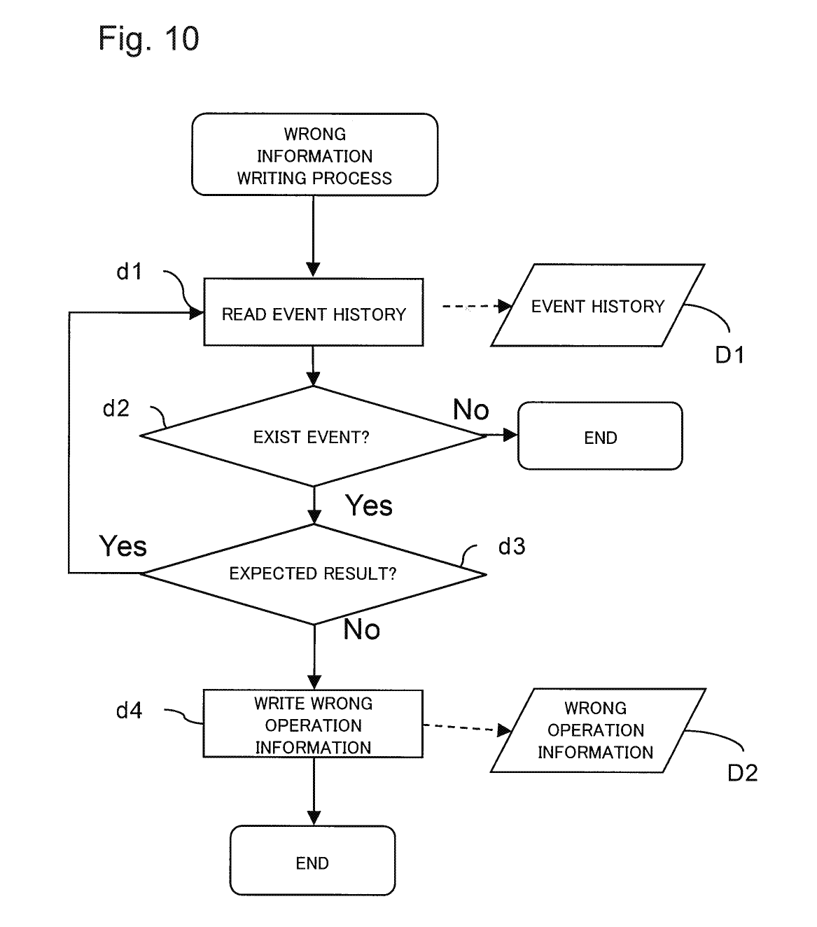

Next, wrong information writing process is described by using FIG. 10.

For detecting wrong information, a wrong operation analyzing unit 122 is used. The wrong operation analyzing unit 122 reads an event history (d1), and when there is an event (d2), the wrong operation analyzing unit 122 determines whether or not its result is an expected one, i.e., a normal one (d3). Concerning this determining process, a determining standard data in which events and normal results are associated with each other may be stored in advance, and the wrong operation analyzing unit 122 may refer to this determining standard data to make determination. A manager may make determination, and the wrong operation analyzing unit 122 may receive input of a result of the determination made by the manager.

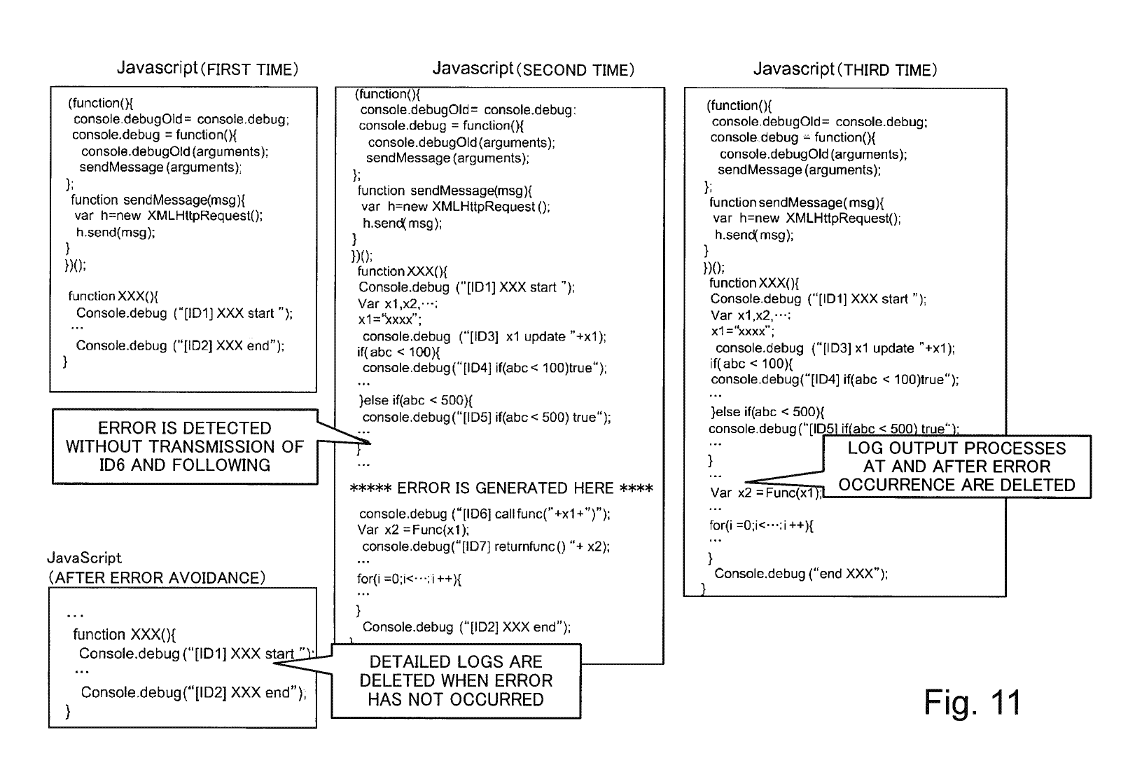

When the result is not an expected one, i.e., not a normal one, log ID of the log and wrong operation contents are recorded as wrong operation information [log ID] by the wrong operation analyzing unit 122 (d4). An example of a script in which a log output process has been inserted is illustrated in FIG. 11.

Advantageous effects according to the present exemplary embodiment are described.

The first advantageous effect is that a log output can be changed without decreasing an information amount of a debug log necessary at the time of malfunction. A reason for this is that by the log-output-location determining unit 131 and the log-output-process embedding unit 132, a log output location can be determined, and a log output process can be embedded. The second advantageous effect is that a log output location can be changed in accordance with an execution record of a program. A reason for this is that using the log generation information 141 and the wrong operation information 142 enables the log-output-location determining unit 131 and the log-output-process embedding unit 132 to embed a log output process in a malfunction-generated location.

### Second Exemplary Embodiment

In a portal product, for each user, a role of a manager or a general user is allocated, and an operational range and a characteristic of operation differ in accordance with authority (function) of each role. For example, a user to whom the manager role is allocated performs operation of a managing system, and a user to whom a general user role is allocated mainly performs operation of a reference system. Using role information of a user that transmits a request at the time of analyzing a log output location can improve narrowing accuracy at the time of determining an output location.

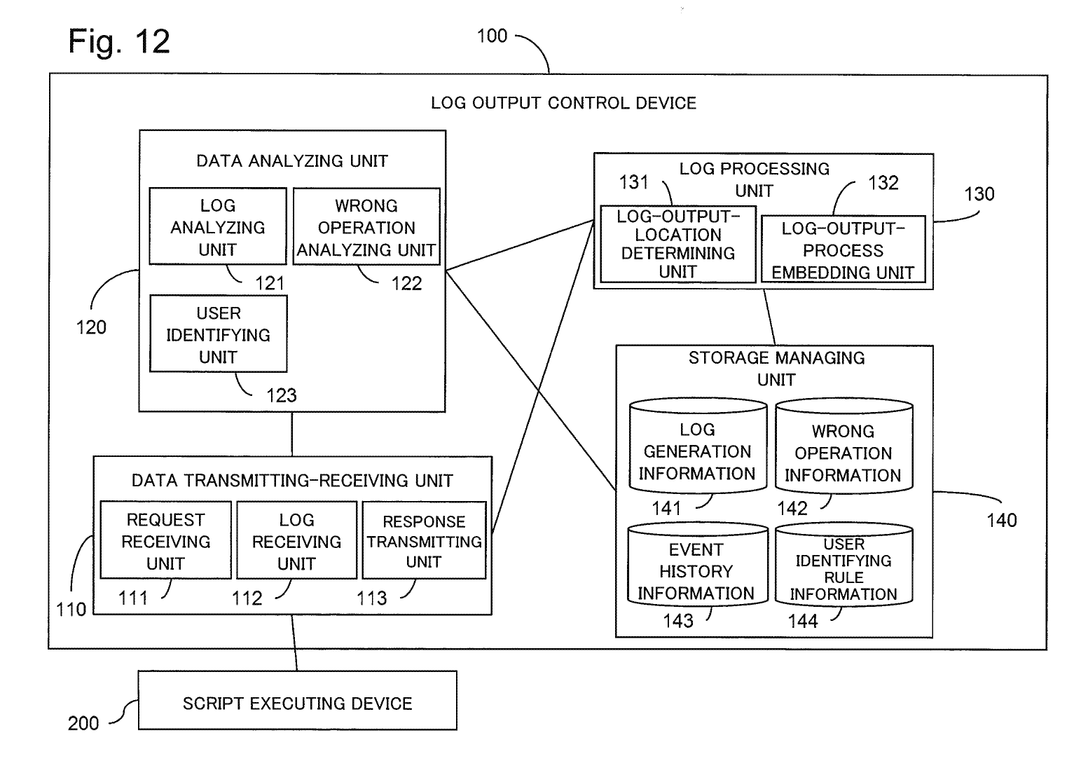

FIG. 12 is a configuration diagram of the second exemplary embodiment of the present invention.

In the present exemplary embodiment, after a process by the request receiving unit 111 in FIG. 6, a process by a user identifying unit 123 is added. The user identifying unit 123 performs user identification by using user identifying rule information defined in advance. The user identifying rule information 144 is stored in the storage managing unit 140. The user identifying unit 123 follows an interface, executes a method, and performs user identification. For the user identifying rule, a rule for identifying a user is described by the java language as exemplified in FIG.

13. When a class file of a code in which the interface for describing the rule is implemented is registered, the registered class file is executed on the server side, and information for classifying a user, such as user ID, a role allocated to the user, IP of a terminal to which a request is transmitted is obtained. When the user is identified, by using the user identification information, the log-output-location determining unit 131 determines contents to be determined. In the event history information, the user identification information (identification information following the rule, such as role information and user ID) is additionally stored. Based on the event history, tendency of operation of the user can be determined by using the identified user information. The user identification information may be added to the wrong operation information. Alternatively, the user identification information may be added to the log generation information.

In accordance with the user identification information, the log-output-location determining unit 131 may determine insertion of a log output process in a program requested by the client. In accordance with the user identification information, the log-output-location determining unit 131 may change an insertion range of a log output process in a program requested by the client.

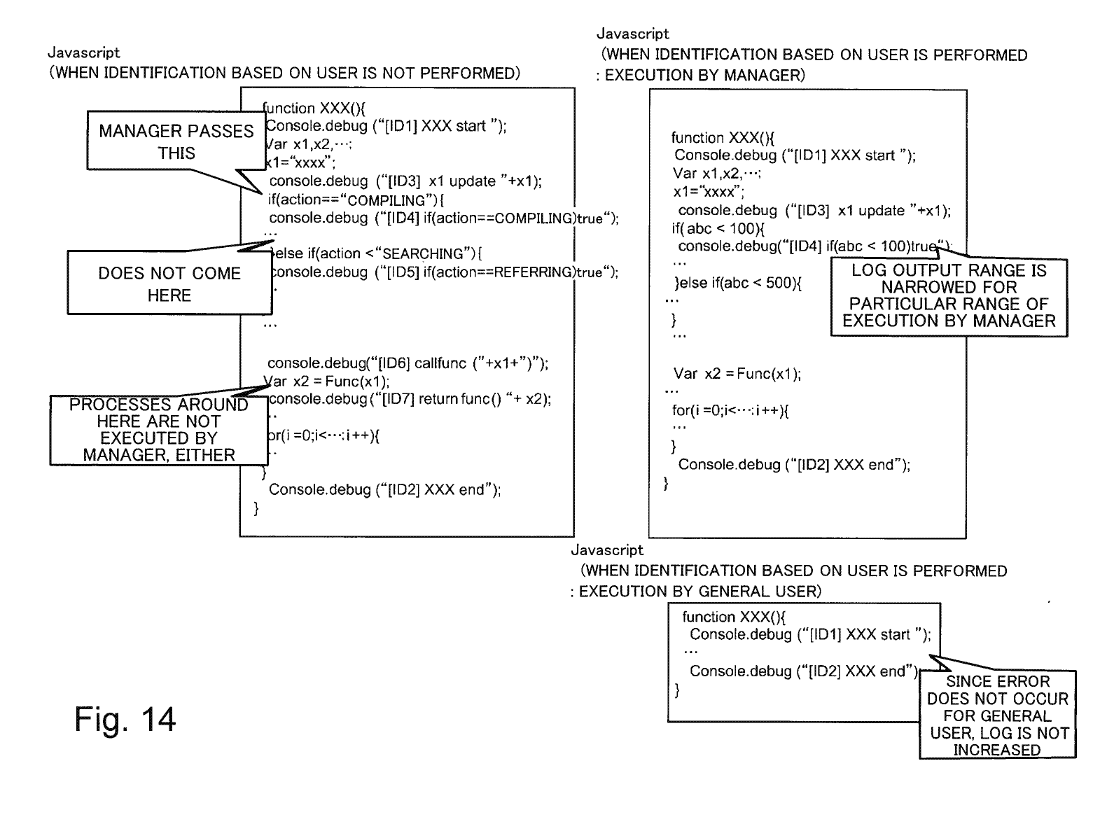

FIG. 14 illustrates insertion result examples of a log output process in a case where user identification is performed, and in a case where user identification is not performed. In the case where user identification is not performed, when an error occurs, a log output process is embedded in the JavaScript at each of a manager and a user. Meanwhile, in the present exemplary embodiment, the log-output-location determining unit 131 determines that an error occurs only at a manager, based on the event history, the wrong operation information, and the log generation information, and embeds a log output process in the JavaScript only in a case of a request from a manager. Further, information such as a range of execution by a manager and a range of execution by a general user is registered in advance, and embedding targets are narrowed down to manager operation so that log output locations can be narrowed as well.

An advantageous effect of the second exemplary embodiment lies in that log output locations can be determined more efficiently than in a case of determining log output locations only from the wrong operation information. The reason for this is that using the user information identified by the user identifying unit 123 enables a log output process to be embedded in an operation range limited in accordance with a user characteristic.

### Third Exemplary Embodiment

In a process including successive operation, operation sometimes fails only from a specific processing sequence. By paying attention to a pattern of operation (transmitted requests to the server) after log-in, narrowing accuracy at the time of determining output locations can be enhanced at the time of analyzing log output locations. In a third exemplary embodiment, when operation A, operation B, and operation C are performed in this order, an error does not occur. In a case where when operation A′, operation B′, and the operation C are performed in this order, an error however occurs in the operation C, requests before operation C are held as a list, so that a log output process is embedded in the operation C only in a case of the flow of the operation A′, the operation B′, and the operation C in this order. This enables log output unnecessary in a case where an error does not occur to be eliminated.

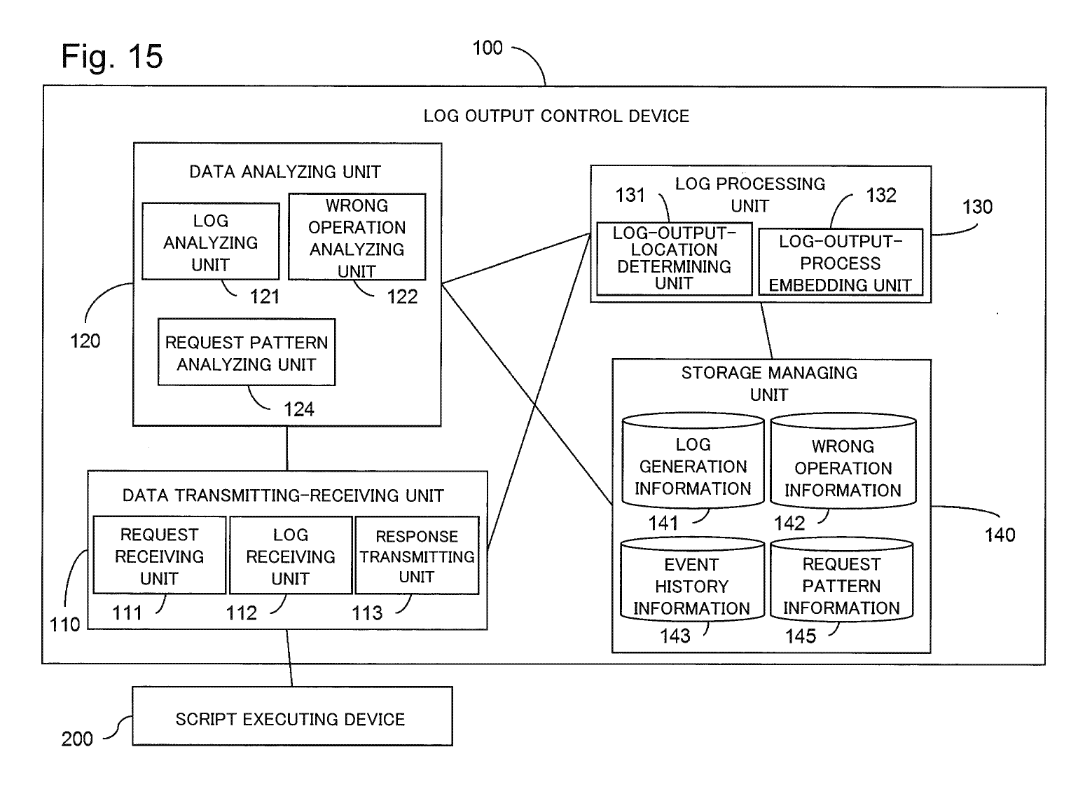

FIG. 15 is a configuration diagram of the third exemplary embodiment of the present invention.

In the present exemplary embodiment, after the process by the request receiving unit 111 in FIG. 6, a process by a request pattern analyzing unit 124 is added.

In the present exemplary embodiment, a list of requests received from the client is accumulated and stored in the storage managing unit 140.

Based on the list of the received requests and wrong operation information 142, the request pattern analyzing unit 124 analyzes a pattern of the received order of requests at the time of occurrence of wrong operation. The request pattern analyzing unit 124 relates the pattern of the requests and the wrong operation information to each other, and stores the corresponding relation in request pattern information 145. For example, in a case where the analysis determines that malfunction occurs when requests are transmitted to the server in the order of the request A, the request B, and the requests C, the request pattern analyzing unit 124 associates the pattern of these requests and the wrong operation information with each other.

Based on the pattern of the received requests, the log-output-location determining unit 131 determines an insertion location of a log output process. When the requests having the same pattern as the pattern (e.g., the order of the request A, the request B, and the request C) registered in the request pattern information 145 exist, and wrong operation occurs, the log-output-location determining unit 131 inserts a log output process at a location corresponding to the request C in the script.

In the same manner as in the second exemplary embodiment, also in the third exemplary embodiment, control for a case of embedding a log output process, and control for a case of not embedding a log output process is performed in accordance with a request pattern. A log output process is embedded with limitation to a specific pattern being made so that unnecessary log output can be avoided, and a load on the server side can be reduced.

An advantageous effect of the third exemplary embodiment lies in that a log output location can be determined more efficiently than in a case of determining a log output location only from the wrong information. The reason for this is that using a pattern detected by the request receiving pattern analyzing unit enables a log output process to be embedded with limitation to an operation range matched with flow of work of the client being made.

The device according to the above-described exemplary embodiments of the present invention may be implemented by a central processing unit (CPU) of the same device reading an operation program or the like stored in a storage unit and executing the operation program or the like, or may be configured by hardware. Only a function of a part of the above-described exemplary embodiments may be implemented by a computer program.

The invention can be applied to a portal product, or a rich client system provided in a cloud region or mobile smartphone region.

A part or all of the above-described exemplary embodiments can be described as in the following Supplemental Notes as well, and is not, however, limited to the following.

### (Supplemental Note 1)

A log output control device that dynamically controls a log output location in a program requested by a client, by using a history of a log output by the client, wrong operation information concerning wrong operation of the program detected from the log, and log generation information concerning a log output process inserted in the program executed by the client.

### (Supplemental Note 2)

The log output control device according to Supplemental Note 1, wherein the wrong operation information includes identification information of the log of the detected wrong operation,

the log generation information includes location information representing a location in the program where the log output process is inserted, and includes identification information of the log corresponding to the inserted log output process, and

based on the wrong operation information and the log generation information, the log output control device specifies an output location of the log of the detected wrong operation in the program requested by the client, and inserts a log output process at the specified location.

### (Supplemental Note 3)

The log output control device according to Supplemental Note 1 or 2, wherein the log output control device obtains user identification information of the client, and

by using the user identification information of the client, controls an inserting process of the log output process for the program requested by the client.

### (Supplemental Note 4)

The log output control device according to Supplemental Note 3, wherein in control of the inserting process of the log output process, in accordance with the user identification information, the log output control device determines insertion of the log output process in the program requested by the client.

### (Supplemental Note 5)

The log output control device according to Supplemental Note 3 or 4, wherein in control of the inserting process of the log output process, in accordance with the user identification information, the log output control device changes an insertion range of the log output process in the program requested by the client.

### (Supplemental Note 6)

The log output control device according to any one of Supplemental Notes 1 to 5, wherein the log output control device controls the inserting process of the log output process for the program requested by the client, based on a pattern of requests received from the client.

### (Supplemental Note 7)

A log output control method comprising controlling dynamically a log output location in a program requested by a client, by using a history of a log output by the client, wrong operation information concerning wrong operation of the program detected from the log, and log generation information concerning a log output process inserted in the program executed by the client.

### (Supplemental Note 8)

The log output control method according to Supplemental Note 7, wherein the wrong operation information includes identification information of the log of the detected wrong operation,

the log generation information includes location information representing a location in the program where the log output process is inserted, and includes identification information of the log corresponding to the inserted log output process, and

based on the wrong operation information and the log generation information, specifying an output location of the log of the detected wrong operation in the program requested by the client, and inserting a log output process at the specified location.

### (Supplemental Note 9)

The log output control method according to Supplemental Note 7 or 8, wherein obtaining user identification information of the client, and

by using the user identification information of the client, controlling an inserting process of the log output process for the program requested by the client.

### (Supplemental Note 10)

The log output control method according to Supplemental Note 9, wherein in control of the inserting process of the log output process, in accordance with the user identification information, determining insertion of the log output process in the program requested by the client.

### (Supplemental Note 11)

The log output control method according to Supplemental Note 9 or 10, wherein in control of the inserting process of the log output process, in accordance with the user identification information, changing an insertion range of the log output process in the program requested by the client.

### (Supplemental Note 12)

The log output control method according to any one of Supplemental Notes 7 to 11, wherein controlling the inserting process of the log output process for the program requested by the client, based on a pattern of requests received from the client.

### (Supplemental Note 13)

A program causing a computer to execute a process of dynamically controlling a log output location in a program requested by a client, by using a history of a log output by the client, wrong operation information concerning wrong operation of the program detected from the log, and log generation information concerning a log output process inserted in the program executed by the client.

### (Supplemental Note 14)

The program according to Supplemental Note 13, wherein the wrong operation information includes identification information of the log of the detected wrong operation,

the log generation information includes location information representing a location in the program where the log output process is inserted, and includes identification information of the log corresponding to the inserted log output process, and

based on the wrong operation information and the log generation information, specifying an output location of the log of the detected wrong operation in the program requested by the client, and inserting a log output process at the specified location.

### (Supplemental Note 15)

The program according to Supplemental Note 13 or 14, wherein obtaining user identification information of the client, and

by using the user identification information of the client, controlling an inserting process of the log output process for the program requested by the client.

### (Supplemental Note 16)

The program according to Supplemental Note 15, wherein in control of the inserting process of the log output process, in accordance with the user identification information, determining insertion of the log output process in the program requested by the client.

### (Supplemental Note 17)

The program according to Supplemental Note 15 or 16, wherein in control of the inserting process of the log output process, in accordance with the user identification information, changing an insertion range of the log output process in the program requested by the client.

### (Supplemental Note 18)

The program according to any one of Supplemental Notes 13 to 17, wherein controlling the inserting process of the log output process for the program requested by the client, based on a pattern of requests received from the client.

Although the present invention is described in the above by citing the preferred exemplary embodiments, the present invention is not necessarily limited to the above-described exemplary embodiments, and can be variously modified within the scope of the technical idea thereof to be implemented.

This application is based upon and claims the benefit of priority from Japanese patent application No. 2013-63593, filed on Mar. 26, 2013, the disclosure of which is incorporated herein in its entirety by reference.

### REFERENCE SIGNS LIST

100 log output control device
110 data transmitting-receiving unit
120 data analyzing unit
130 log processing unit
140 storage managing unit
111 request receiving unit
112 log receiving unit
113 response transmitting unit
121 log analyzing unit
122 wrong operation analyzing unit
131 log-output-location determining unit
132 log-output-process embedding unit
141 log generation information
142 wrong operation information
143 event history information
200 script executing device

What is claimed is:

1. A log output control device comprising:
a log processing unit that dynamically controls a log output location in a program requested by a client, by using a history of a log output by the client, wrong operation information concerning wrong operation of the program detected from the log, and log generation information concerning a log output process inserted in the program executed by the client.

2. The log output control device according to claim 1, wherein the wrong operation information includes identification information of the log of the detected wrong operation,
the log generation information includes location information representing a location in the program where the log output process is inserted, and includes identification information of the log corresponding to the inserted log output process, and
based on the wrong operation information and the log generation information, the log processing unit specifies an output location of the log of the detected wrong operation in the program requested by the client, and inserts a log output process at the specified location.

3. The log output control device according to claim 1, wherein the log processing unit obtains user identification information of the client, and
by using the user identification information of the client, controls an inserting process of the log output process for the program requested by the client.

4. The log output control device according to claim 3, wherein in control of the inserting process of the log output process, in accordance with the user identification information, the log processing unit determines insertion of the log output process in the program requested by the client.

5. The log output control device according to claim 3, wherein in control of the inserting process of the log output process, in accordance with the user identification information, the log processing unit changes an insertion range of the log output process in the program requested by the client.

6. The log output control device according to claim 1, wherein the log processing unit controls the inserting process of the log output process for the program requested by the client, based on a pattern of requests received from the client.

7. A log output control method comprising
controlling dynamically a log output location in a program requested by a client, by using a history of a log output by the client, wrong operation information concerning wrong operation of the program detected from the log, and log generation information concerning a log output process inserted in the program executed by the client.

8. A non-transitory computer-readable recording medium recorded with a program causing a computer to execute a process of dynamically controlling a log output location in a program requested by a client, by using a history of a log output by the client, wrong operation information concerning wrong operation of the program detected from the log, and log generation information concerning a log output process inserted in the program executed by the client.
